(19) United States
(12) Patent Application Publication
(10) Pub. No.: US 2020/0320896 A1
(43) Pub. Date: Oct. 8, 2020

(54) INFORMATION PROCESSING DEVICE, INFORMATION PROCESSING METHOD, AND PROGRAM

(71) Applicant: SONY CORPORATION, TOKYO (JP)

(72) Inventors: HIDEYUKI MATSUNAGA, KANAGAWA (JP); ATSUSHI NODA, TOKYO (JP); AKIHITO OSATO, KANAGAWA (JP)

(21) Appl. No.: 16/496,590

(22) PCT Filed: Mar. 8, 2018
(86) PCT No.: PCT/JP2018/009064

§ 371 Date: Sep. 23, 2019

(30) Foreign Application Priority Data
Mar. 29, 2017 (JP) 2017-064444

(51) Int. Cl. G09B 9/042; G09B 9/05; B60K 35/00

(52) U.S. Cl. CPC G09B 9/042; G09B 9/05; B60K 2370/16; B60K 2370/152; B60K 35/00

(57) ABSTRACT

A configuration of selecting content corresponding to the driving situation of a driver and presenting the content to the driver, thereby enabling improvement of the safe driving consciousness of the driver, can be implemented. The configuration includes a situation data acquisition unit that acquires automobile driving situation data, an output content determination unit that determines output content on the basis of the situation data, and a content output unit that outputs the output content determined by the output content determination unit. The output content determination unit determines, as the output content, content including the details of a situation that matches or that is similar to the situation data. The output content determination unit determines, as the output content, content including the details of a risk or an accident in a situation that matches or that is similar to the situation data.

### TECHNICAL FIELD

The present disclosure relates to an information processing device, an information processing method, and a program. More specifically, the present disclosure relates to an information processing device, an information processing method, and a program by which content output for improving safety in driving an automobile is executed.

### BACKGROUND ART

For example, in renewal of driver licenses or the like, there is a case of presenting, to drivers who are to renew driver licenses, video content for indicating the situations of accidents in a safety driving training course.

The content about accidents is presented in order to make the drivers feel the horror of traffic accidents and improve the safe driving consciousness of the drivers.

However, in such a training course, drivers are seated in chairs prepared in a classroom where the training course is held, and view the content about accidents, etc. Accordingly, the drivers are likely to take the accidents included in the viewing content as an other people's matter irrelevant to the drivers themselves.

Content presenting processing in such a safety training course has a problem that the task of improving the safe driving consciousness cannot be sufficiently accomplished because drivers forget the details of viewing content right away.

### CITATION LIST

### Patent Literature

[PTL 1]

Japanese Patent Laid-Open No. 2015-179445

### SUMMARY

### Technical Problem

One of the reasons why, even when viewing image content about accidents in a safety training course, etc., viewers cannot feel reality, is that the viewers view the content while being seated in chairs in a classroom. That is, one of the reasons is a viewing environment in which the viewers are not driving automobiles but are seated in chairs in a safe classroom having no possibility of accidents.

On the other hand, for example, when a driver is made to view image content including a scene of an accident caused by sudden braking immediately after the driver applies sudden braking, the driver seriously views the viewing content and are deeply impressed.

An object of the present disclosure is to provide an information processing device, an information processing method, and a program for implementing such effective content provision, for example.

Specifically, for example, an object of the present disclosure is to provide an information processing device, an information processing method, and a program by which a driving situation is acquired by means of a sensor or the like mounted on a vehicle, and content corresponding to the driving situation is timely presented to a driver, whereby safe driving consciousness of the driver can be improved.

Note that a configuration of acquiring a driving situation by means of a sensor or the like mounted on a vehicle, is disclosed in PTL 1 (Japanese Patent Laid-Open No. 2015-179445), etc., for example.

### Solution to Problem

A first aspect of the present disclosure is an information processing device including:

a situation data acquisition unit that acquires driving situation data of an automobile;

an output content determination unit that determines output content on the basis of the situation data; and

a content output unit that outputs the output content determined by the output content determination unit, in which

the output content determination unit determines, as the output content, content including details of a situation that matches or that is similar to the situation data.

Furthermore, a second aspect of the present disclosure is an information processing method which is performed by an information processing device, the method including:

a situation data acquisition step of acquiring driving situation data of an automobile by means of a situation data acquisition unit;

an output content determination step of determining output content on the basis of the situation data by means of an output content determination unit; and

a content output step of outputting the output content determined by the output content determination unit by means of a content output unit, in which

in the output content determination step,

as the output content, content including details of a situation that matches or that is similar to the situation data is determined.

Moreover, a third aspect of the present disclosure is a program which causes an information processing device to execute information processing including:

a situation data acquisition step of causing a situation data acquisition unit to acquire driving situation data of an automobile;

an output content determination step of causing an output content determination unit to determine output content on the basis of the situation data; and

a content output step of causing a content output unit to output the output content determined by the output content determination unit, in which

in the output content determination step,

as the output content, content including details of a situation that matches or that is similar to the situation data is determined.

Note that a program according to the present disclosure can be provided by a storage medium or a communication medium for providing the program in a computer readable format to an information processing device or computer system that is capable of executing various program codes, for example. Since such a program is provided in a computer readable format, processing in accordance with the program is executed on the information processing device or the computer system.

Other objects, features, and advantages of the present disclosure will become apparent from the detailed description based on the embodiments of the present disclosure and the attached drawings which are described later. Note that, in the present description, a system refers to a logical set configuration including a plurality of devices, and the devices of the configuration are not necessarily included in the same casing.

### Advantageous Effect of Invention

With the configuration according to one embodiment of the present disclosure, a configuration of selecting content corresponding to the driving situation of a driver and presenting the content to the driver, thereby enabling improvement of the safe driving consciousness of the driver, can be implemented.

Specifically, the configuration includes a situation data acquisition unit that acquires automobile driving situation data, an output content determination unit that determines output content on the basis of the situation data, and a content output unit that outputs the output content determined by the output content determination unit. The output content determination unit determines, as the output content, content including the details of a situation that matches or that is similar to the situation data. The output content determination unit determines, as the output content, content including the details of a risk or an accident in a situation that matches or that is similar to the situation data.

With the present configuration, a configuration of selecting content corresponding to the driving situation of a driver and presenting the content to the driver, thereby enabling improvement of the safe driving consciousness of the driver, can be implemented.

Note that the effects described in the present description are just examples, and thus, are not limited. Further, an additional effect may also be provided.

### BRIEF DESCRIPTION OF DRAWINGS

FIG. 1 is an explanatory diagram of an example of general content presentation.

FIG. 2 is an explanatory diagram of an example of existing content presentation and an example of improved content presentation.

FIG. 3 is an explanatory diagram of output content corresponding to contexts.

FIG. 4 is an explanatory diagram of an example of an output unit that outputs content.

FIG. 5 is an explanatory diagram of a configuration example of an information processing device.

FIG. 6 is an explanatory diagram of an example of a context-output content correspondence map.

FIG. 7 is an explanatory diagram of an example of an output unit that outputs content.

FIG. 8 is an explanatory diagram of an example of an output unit that outputs content.

FIG. 9 is a flowchart of an information processing sequence that is executed by the information processing device.

FIG. 10 is an explanatory diagram of a hardware configuration example of the information processing device.

### DESCRIPTION OF EMBODIMENTS

Hereinafter, an information processing device, an information processing method, and a program according to the present disclosure will be explained with reference to the drawings. The explanations will be given in the following order.

1. Existing State and Problems of Method for Providing Content to Drivers

2. Configuration of Executing Content Output Corresponding to Situation

3. Sequence of Processing Which Is Executed by Information Processing Device

4. Configuration Example of Information Processing Device

5. Conclusion of Configuration According to Present Disclosure

[1. Existing State and Problems of Method for Providing Content to Drivers]

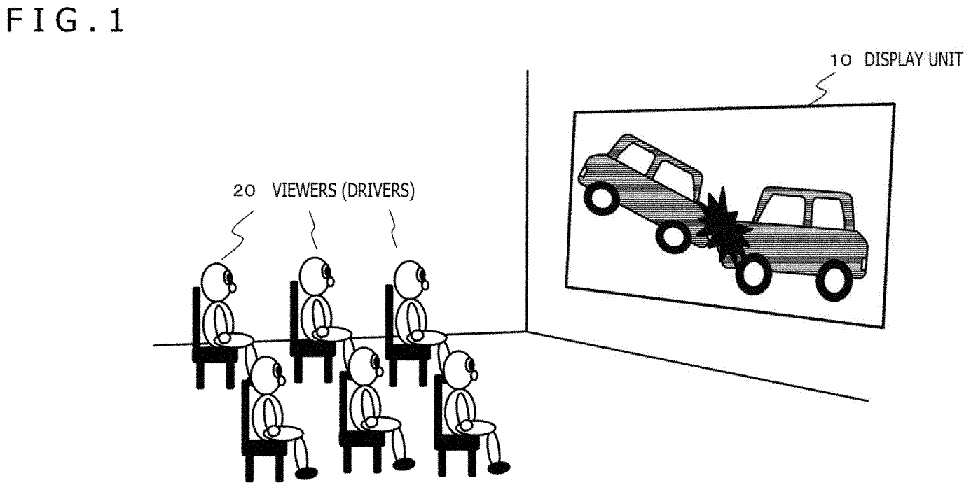

First, the existing state and problems of a method for presenting content to drivers will be explained with reference to FIG. 1.

As described above, in many cases, drivers are trained to carry out safe driving by presentation of image content about an accident in a safe driving training course for renewal of driver licenses, for example.

However, in such a training course, viewers (drivers) 20 view image content about an accident displayed on a display unit 10 while being seated in safe chairs prepared in a classroom where the training course is held, as illustrated in FIG. 1, for example.

This situation has a problem that the drivers who are the viewers take an accident in the viewing content as an other people's matter, and thus, are less likely to take the accident as their own problem.

That is, when the content is provided under this situation, the content viewers forget the details of the viewing content right away. This leads to a problem that an effect of improving the safe driving consciousness of the viewers (drivers) is less likely to be exerted.

In contrast, for example, when a driver is made to view image content including a scene of an accident caused by sudden braking immediately after the driver applies sudden braking, the driver seriously views the viewing content and are deeply impressed. Accordingly, the consciousness of necessity of safe driving is improved.

Thus, in order to effectively improve the safe driving consciousness of a driver, setting the details of content and a timing for presenting the content in accordance with the situation of a viewer (driver) is important.

The present disclosure implements a configuration for conducting such effective content provision, for example.

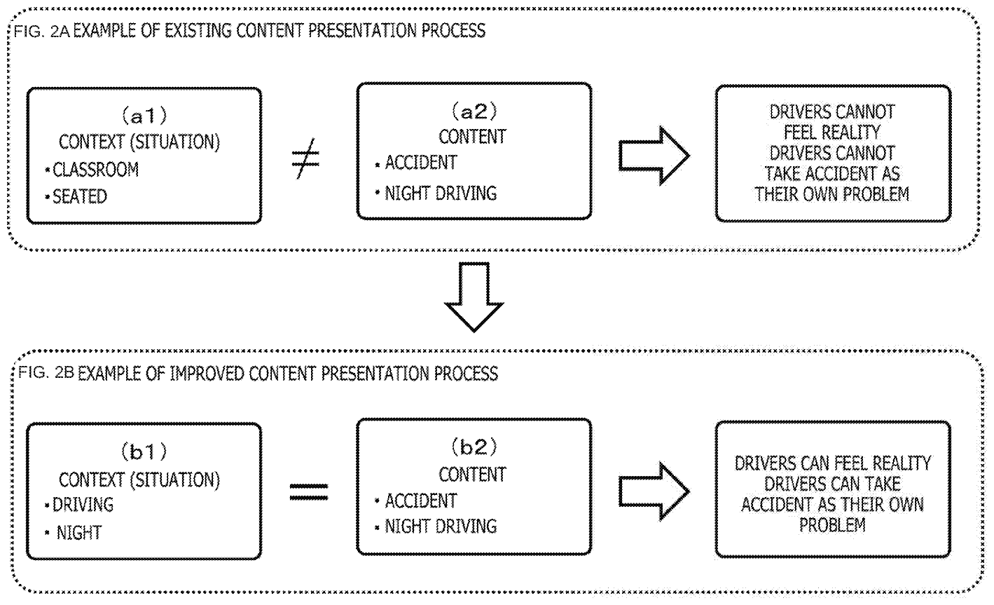

FIG. 2 is an explanatory diagram of the difference between an example of a conventional content presentation process and an example of a content presentation process according to the present disclosure.

FIG. 2 includes the following diagrams (A) and (B).

(A) an example of an existing content presentation process

(B) an example of an improved content presentation process.

In the example of an existing content presentation process

(A) :

(a1) the content viewing situation (context) is a situation (context) of being seated in a classroom; and

(a2) content to be presented is image content about an accident or night driving.

When there is a gap between a content viewing situation (context) and the details of content to be presented as in this case, a content viewer cannot feel reality from the viewing content, and cannot seriously take an accident as an own problem. That is, the content viewing effect is small.

In contrast, the example of an improved content presentation process (B) is equivalent to a process according to the present disclosure, which will be explained below:

(b1) the content viewing situation (context) is driving at night; and

(b2) content to be presented is image content about an accident during night driving.

In this example, the content viewing situation (context) matches the details of the content to be presented. In this case, the content viewer can feel reality from the viewing content, and can seriously take the content as an own problem. That is, the content viewing effect can be increased.

Note that a timing for presenting content, which will be explained in detail later, in the processing according to the present disclosure is set in a time period during which an automobile is stopped by a driver. That is, content is presented in a time period during which the content can be safely viewed.

For example, in the case where content is presented during night driving which has been explained with reference to FIG. 2, an actual timing for presenting the content is not in a time period during which the automobile is moving, but is in a time period during which the automobile is parked in a road shoulder or a PA (Parking Area), for example.

[2. Configuration of Executing Content Output Corresponding to Situation]

Next, a specific embodiment of the configuration of executing content output corresponding to a situation will be explained.

That is, a specific example of the improved content presentation process having been explained with reference to FIG. 2(B), will be explained.

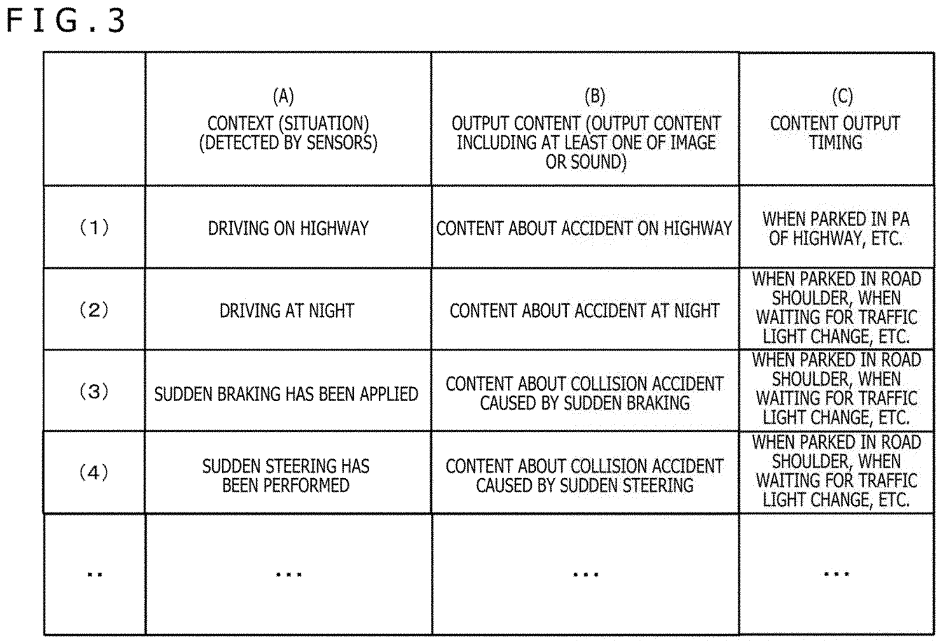

FIG. 3 is an explanatory diagram of a specific example of a configuration of executing content output corresponding to a situation.

FIG. 3 depicts a table of correspondence data on the following items (A) to (C):

(A) context (situation);

(B) output content; and

(C) content output timing

The context (situation) (A) indicates a context to be used as a condition for outputting content the details of which are specific, that is, indicates the situation of a driver who is a viewer of the content.

The situation of the driver is acquired by various situation detection devices (sensor, camera, etc.) mounted on an automobile.

The output content (B) indicates an example of details of output content to be presented to the driver in the case where the context (situation) (A) is confirmed. Note that the content is not limited to video content such as a moving image, and various content such as still image content and content including only a sound such as a warning sound can be used therefor.

The content output timing (C) indicates an example of a timing of outputting the content (B). The content output is preferably executed at a timing when the automobile is parked in a parking region such as a road shoulder or a PA (Parking Area) such that the driver who is a viewer can concentrate on the content. Note that, in the case where the content includes only a sound such as a warning sound, the content may be configured so as to be outputted during driving.

A plurality of the specific examples depicted in FIG. 3 will be explained.

(1) represents an example of outputting content corresponding to the following situation.

(1a) context (situation)=driving on a highway

(1b) output content=video content about an accident on a highway

(1c) content output timing=during parking in a PA in a highway

The example (1) represents a content presentation example that is executed while the driver who is a content viewer is driving on a highway.

When, during driving on a highway, the driver parks the automobile in a PA in the middle of travel, the content is outputted to an output unit (display unit or loudspeaker) of the automobile.

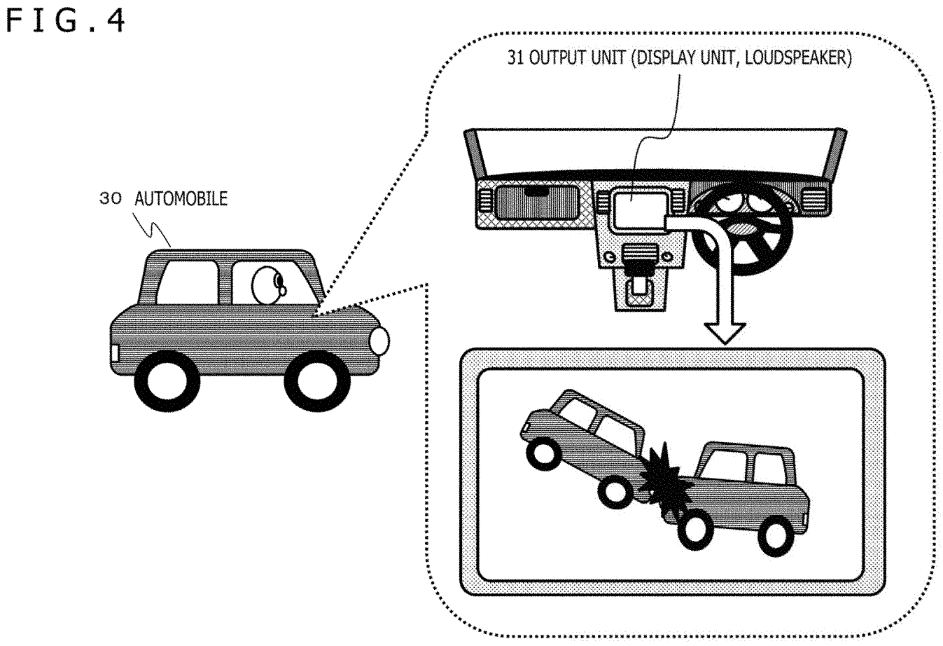

For example, as depicted in FIG. 4, the content is outputted to an output unit 31 (display unit or loudspeaker) provided to an automobile 30.

The output content is video content about an accident on a highway.

The driver who is a content viewer is driving on a highway. Thus, by viewing the video content about an accident on a highway, the driver is expected to try to drive safely so as not to cause an accident.

Note that analysis of the context (situation), selection of the output content, and the content output timing, etc., are all controlled by a control unit of the information processing device installed in the automobile.

(2) in FIG. 3 represents an example of outputting content corresponding to the following situation.

(2a) context (situation)=driving at night

(2b) output content=video content about an accident at night

(2c) content output timing=during parking at a road shoulder or a parking place

The example (2) is a content presentation example that is executed when the driver who is a content viewer is driving at night.

When, during driving at night, the driver parks the automobile in a road shoulder or a parking place, for example, the content is outputted to the output unit (display unit or loudspeaker) of the automobile.

The output content is video content about an accident at night.

The driver who is a content viewer, is driving at night. Thus, by viewing the video content about an accident at night, the driver is expected to try to drive safely so as not to cause an accident.

(3) represents an example of outputting content corresponding to the following situation.

(3a) context (situation)=sudden braking has been applied

(3b) output content=video content about an accident caused by sudden braking

(3c) content output timing=during parking in a road shoulder or a parking place

The example (3) represents a content presentation example that is executed in a time period during which the automobile is parked after the driver who is a content viewer applies sudden braking.

When, during driving, the driver applies sudden braking, and then, parks the automobile in a road shoulder or a parking place, for example, the content is outputted to the output unit (display unit or loudspeaker) of the automobile.

The output content is content about an accident of a collision, etc., caused by sudden braking.

The driver who is a content viewer has just applied sudden braking. Thus, by viewing the video content about an accident caused by sudden braking, the driver is expected to try to drive safely so as not to apply sudden braking.

(4) represents an example of outputting content corresponding to the following situation.

(4a) context (situation)=sudden steering has been performed

(4b) output content=video content about an accident caused by sudden steering

(4c) content output timing=during parking in a road shoulder or a parking place

The example (4) represents a content presentation example that is executed in a time period during which the automobile is parked after the driver who is a content viewer performs sudden steering.

When, during driving, the driver performs sudden steering, and then, for example, parks the automobile in a road shoulder or a parking place, the content is outputted to the output unit (display unit or loudspeaker) of the automobile.

The output content is content about an accident such as a collision caused by sudden steering.

The driver who is a content viewer has just performed sudden steering. Thus, by viewing the video content about an accident caused by sudden steering, the driver is expected to try to drive safely so as not to perform sudden steering.

FIG. 3 indicates examples of the content to be provided and the timings for presenting the content for four context (situation) settings. However, the content presentation examples can include various other examples corresponding to other various contexts (situations).

As explained above, the present disclosure has the configuration of quickly presenting, to the driver, content about an accident, etc., in a situation that matches or that is similar to the latest situation of the driver.

Note that, as explained above, analysis of the context (situation), selection of the output content, and the content output timing, etc., are all controlled by a control unit of the information processing device installed in the automobile.

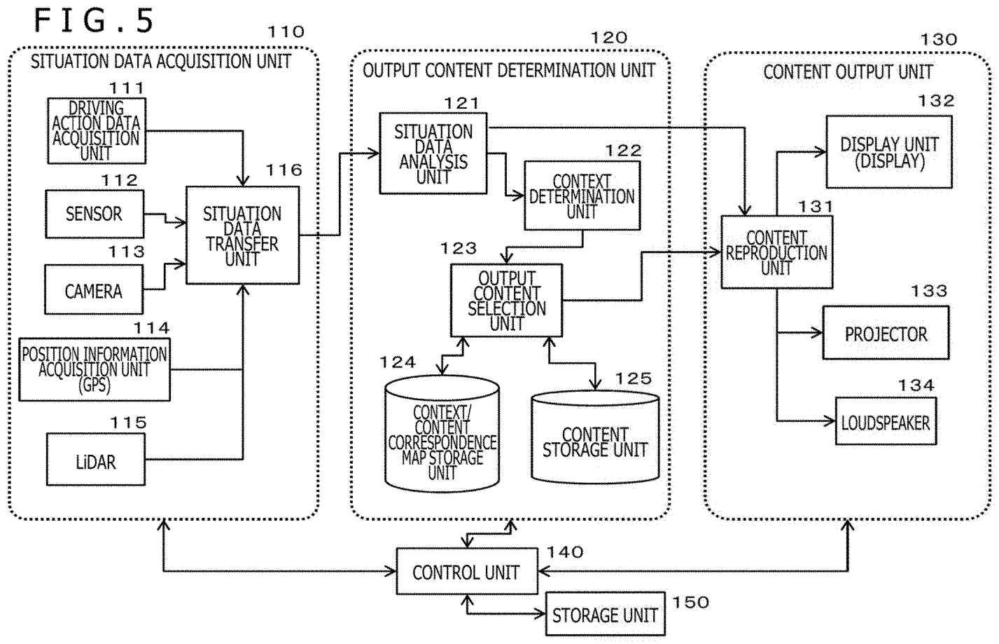

A specific configuration example of the information processing device that executes the aforementioned processing will be described with reference to FIG. 5.

FIG. 5 is a configuration diagram of the information processing device which is installed in an automobile, and is a block diagram depicting a configuration example of the information processing device that executes context (situation) analysis processing, selection of output content, and control of the content output timing, etc.

As depicted in FIG. 5, the information processing device includes a situation data acquisition unit 110, an output content determination unit 120, a content output unit 130, a control unit 140, and a storage unit 150.

The situation data acquisition unit 110 acquires situation data on a driver of an automobile, and outputs the acquired data to the output content determination unit 120.

The output content determination unit 120 analyzes the situation data acquired by the situation data acquisition unit 110, executes a context determination process, etc., and further, executes a process of determining output content corresponding a context (the situation of the driver).

For example, during driving on a highway, the output content determination unit 120 executes a process of selecting content about an accident on a highway.

The content output unit 130 outputs the content determined by the output content determination unit 120.

The control unit 140 comprehensively controls the processing which are executed by these processing units including the situation data acquisition unit 110, the output content determination unit 120, and the content output unit 130.

The storage unit 150 stores a processing program, a processing parameter, and the like, and further, is used as a work area for the processing which are executed by the control unit 140 and the like, for example.

The control unit 140 executes control of various kinds of processing in accordance with the program stored in the storage unit 150, for example.

Next, the detailed configuration of each of the situation data acquisition unit 110, the output content determination unit 120, and the content output unit 130, and examples of processing thereof will be explained.

As depicted in FIG. 5, the situation data acquisition unit 110 includes a driving action data acquisition unit 111, a sensor 112, a camera 113, a position information acquisition unit (GPS) 114, a LiDAR 115, and a situation data transfer unit 116.

The driving action data acquisition unit 111, the sensor 112, the camera 113, the position information acquisition unit (GPS) 114, and the LiDAR 115 each acquire the driving situation of a driver of the automobile, i.e., various kinds of situation data to be applied for analysis of contexts.

Specifically, examples of the situation data include travel information such as a travel distance, a travel time, a travel time period, a travel speed, and a travel route, positional information, the number of occupants, the type of a travel road (for example, highway or ordinary road), operation information regarding an accelerator, a brake, or a steering wheel, and information regarding the surrounding condition of the automobile.

Note that the LiDAR (Light Detection and Ranging, Laser Imaging Detection and Ranging) 115 refers to a unit for acquiring, by using a pulsed laser beam, the surrounding situation of an automobile or surrounding area information regarding a pedestrian, an oncoming automobile, a sidewalk, or an obstacle, for example.

Further, FIG. 5 depicts one sensor 112 as the sensor. However, the sensor 112 includes a plurality of sensors that detects operation information, etc., regarding an accelerator, a brake, and a steering wheel, besides the travel information.

The situation data transfer unit 116 accumulates data acquired by the driving action data acquisition unit 111, the sensor 112, the camera 113, the position information acquisition unit (GPS) 114, and the LiDAR 115, and transfers the data to the output content determination unit 120.

The output content determination unit 120 includes a situation data analysis unit 121, a context determination unit 122, an output content selection unit 123, a context/content correspondence map storage unit 124, and a content storage unit 125.

The situation data analysis unit 121 analyzes the situation data inputted from the situation data acquisition unit 110, and transfers a result of the analysis to the context determination unit 122. Note that the situation data analysis unit 121 acquires situation information indicating whether or not the automobile is parked, from the situation data inputted from the situation data acquisition unit 110, and outputs the situation information to a content reproduction unit 131 of the content output unit 130. This information is used for content output based on confirmation of the parked state of the automobile. That is, this information is used for control of the content output timing.

The context determination unit 122 selects and determines a context that can be applied for determining the output content on the basis of the situation data inputted from the situation data analysis unit 121. Various kinds of situation data acquired from the situation data analysis unit 121 by the situation data acquisition unit 110 is inputted to the context determination unit 122. The context determination unit 122 selects and determines a context that can be applied for determining the output content on the basis of the various kinds of situation data. A result of this is inputted to the output content selection unit 123.

The output content selection unit 123 determines optimal content corresponding to the driving situation (context) by using the map stored in the context/content correspondence map storage unit 124.

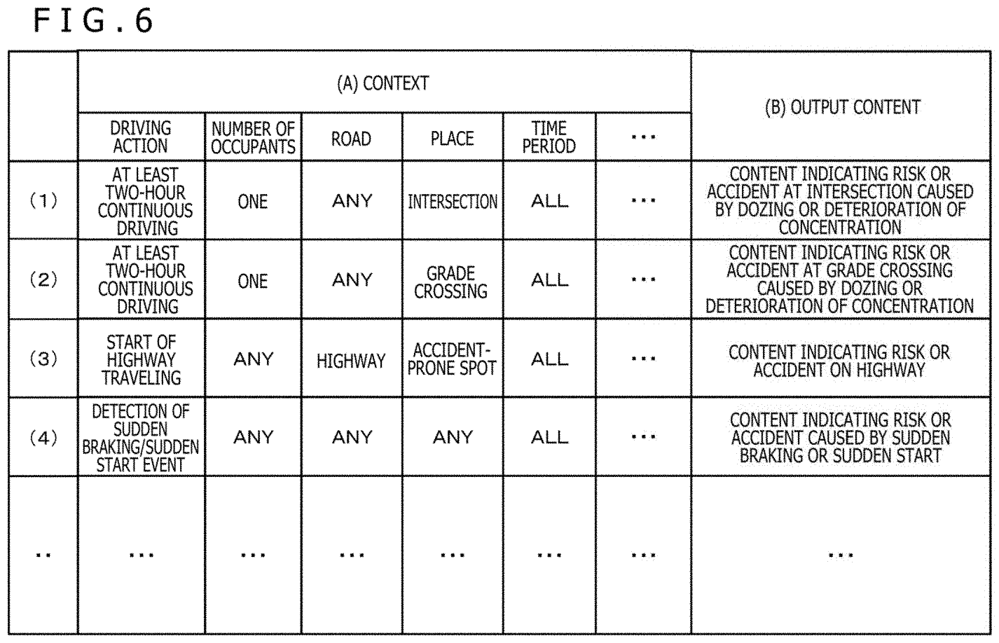

FIG. 6 depicts a specific example of the context/content correspondence map stored in the context/content correspondence map storage unit 124.

As depicted in FIG. 6, the context/content correspondence map is map data in which the following data sets are associated with each other.

(A) Context

(B) Output Content

Examples of entries set in the context/content correspondence map depicted in FIG. 6 will be explained.

In a data entry (1),

a context (situation) including

driving action=at least two-hour continuous driving,

the number of occupants=one,

road=ANY,

place=intersection,

time period=ALL, and

. . .

is recorded as the context (A).

The output content (B) set in association with the above context is “content indicating a risk or an accident at an intersection caused by dozing or deterioration of concentration.”

This content is selected on the basis of the expectation that the possibility of a risk or an accident at an intersection is increased by dozing or deterioration of the concentration in the case where at least two-hour continuous driving is conducted under the condition that the number of occupants is one.

In the case where the context inputted from the context determination unit 122 is determined to match or be similar to the context depicted in (1) of FIG. 6, the output content selection unit 123 decides to use, as the output content, the “content indicating a risk or an accident at an intersection caused by dozing or deterioration of concentration” which is set as the output content in the entry (1) in FIG. 6.

In a data entry (2) depicted in FIG. 6,

a context (situation) including

driving action=at least two-hour continuous driving,

the number of occupants=one,

road=ANY,

place=grade crossing,

time period=ALL, and

. . .

is recorded as the context (A).

The output content (B) set in association with the above context is
(B) output content=“content indicating a risk or an accident at a grade crossing caused by dozing or deterioration of concentration.”

This content is selected on the basis of the expectation that the possibility of a risk or an accident at a grade crossing is increased by dozing or deterioration of the concentration in the case where at least two-hour continuous driving is conducted under the condition that the number of occupants is one.

In the case where the context inputted from the context determination unit 122 is determined to match or be similar to the context depicted in (2) of FIG. 6, the output content selection unit 123 decides to use, as the output content, “content indicating a risk or an accident at a grade crossing caused by dozing or deterioration of concentration” which is set as the output content in the entry (2) of FIG. 6.

In a data entry (3) depicted in the map in FIG. 6,

a context (situation) including

driving action=start of highway traveling,

the number of occupants=ANY,

road=highway,

place=accident-prone spot, and

time period=ALL,

. . .

is recorded as the context (A).

The output content (B) set in association with the above context is

(B) output content=“content indicating a risk or an accident on a highway.”

This content is selected on the basis of the expectation that the possibility of a risk or an accident on a highway is increased in the case where traveling on a highway is started.

In the case where the context inputted from the context determination unit 122 is determined to match or be similar to the context depicted in (3) of FIG. 6, the output content selection unit 123 decides to use, as the output content, “content indicating a risk or an accident on a highway” which is set as the output content in the entry (3) of FIG. 6.

In a data entry (4) depicted in the map in FIG. 6, a context (situation) including driving action=detection of sudden braking or sudden start event,

the number of occupants=ANY,

road=ANY,

place=ANY,

time period=ALL, and

. . .

is recorded as the context (A).

The output content (B) set in association with the above context is

(B) output content=“content indicating a risk or an accident caused by sudden braking or sudden start.”

This content is selected on the basis of the expectation that the possibility of a risk or an accident due to sudden braking or sudden start is increased in the case where sudden braking or sudden start is performed.

In the case where the context inputted from the context determination unit 122 is determined to match or be similar to the context set in (4) of FIG. 6, the output content selection unit 123 decides to use, as the output content, the “content indicating a risk or an accident caused by sudden braking or sudden start” which is set as the output content in the entry (4) in FIG. 6.

Note that the example of entries set in the context/content correspondence map depicted in FIG. 6 is merely one example. Besides these entries, various kinds of correspondence data on contexts and output content are recorded in the map.

Referring back to FIG. 5, the explanation of the configuration of the information processing device and the processing thereof will be resumed.

As described above, the output content selection unit 123 of the output content determination unit 120 determines the content to be outputted, by referring to the context/content correspondence map stored in the context/content correspondence map storage unit 124, i.e., the context/content correspondence map storing the data which has been explained with reference to FIG. 6.

Furthermore, the output content selection unit 123 acquires the determined output content from the content storage unit 125, and inputs the output content to the content output unit 130.

Various kinds of content, i.e., various kinds of content registered in the context/content correspondence map is stored in the content storage unit 125.

Next, the configuration of the content output unit 130 and processing thereof will be explained.

The content output unit 130 incudes the content reproduction unit 131, a display unit (display) 132, a projector 133, and a loudspeaker 134. Note that the projector 133 is configured so as to be usable in the case where projection display of content is executed. Thus, the projector 133 can be omitted in the case where setting is performed such that no projection display is executed.

The content reproduction unit 131 of the content output unit 130 receives an input of the content corresponding to the context from the output content determination unit 120, and executes reproduction processing of the inputted content. Reproduction content is outputted with use of the display unit (display) 132, the projector 133, and the loudspeaker 134.

Note that the content is not limited to moving image content, and thus, various kinds of content such as still image content or content including only a sound can be outputted.

Note that the content output processing is executed at a timing when the automobile is parked.

As explained above, the content reproduction unit 131 receives, from the situation data analysis unit 120, an input of situation data indicating whether or not the automobile is parked, and outputs the content in the case where the parked state of the automobile is confirmed on the basis of this situation data.

Note that the content is not limited to moving image content, and thus, various kinds of content such as still image content or content including only a sound can be outputted.

The driver of the automobile views the content corresponding to the current situation of the driver, and thus, can feel, as an own problem, the reality of a scene of a risk or an accident included in the viewing content. Accordingly, through the content viewing, the safe driving consciousness of the driver can be improved.

Examples of the specific configuration of the content output unit include a display unit and a loudspeaker, etc., that can be observed from the driver seat of the automobile, for example. Specifically, the content output unit is the output unit 31 having been explained with reference to FIG. 4.

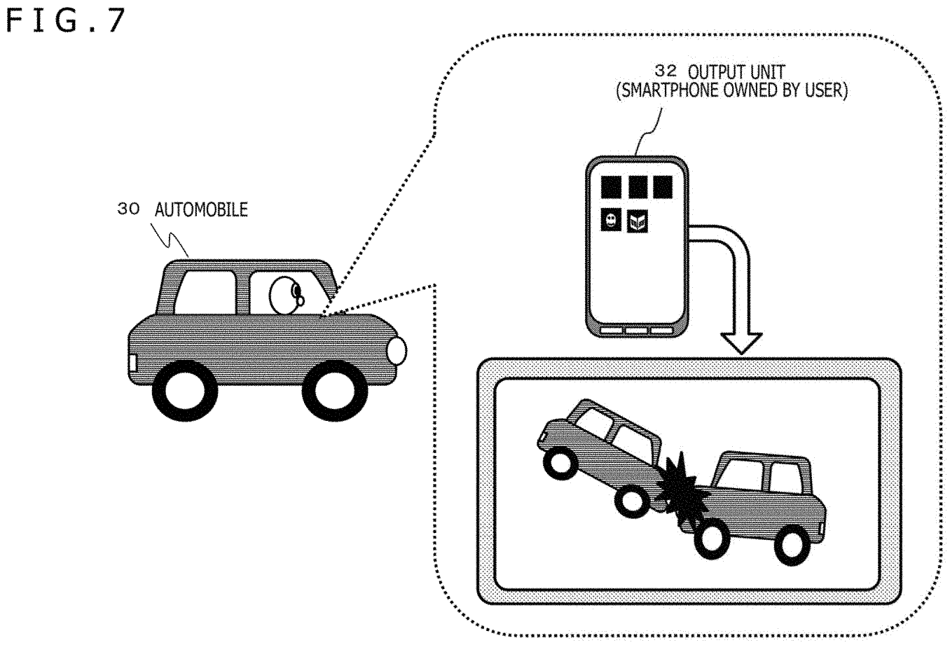

However, the content output unit 130 is not limited to such an output unit provided to the automobile. For example, a mobile terminal of the driver, or specifically, a mobile terminal such as a smartphone may be used, as depicted in FIG. 7.

FIG. 7 depicts an example of the output unit 32 using a mobile terminal (smartphone) of the driver.

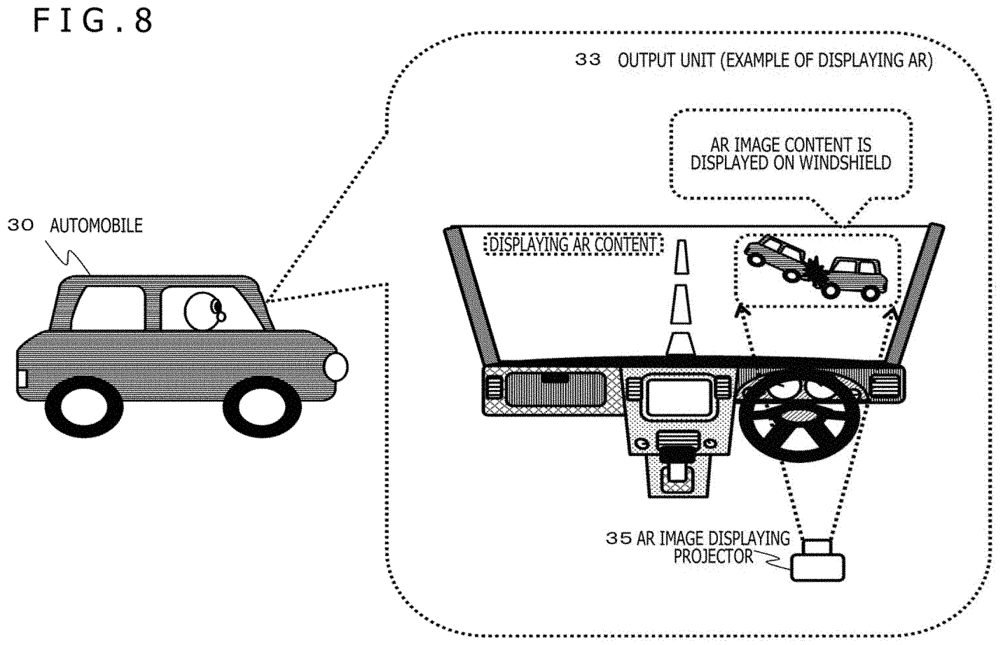

Furthermore, as depicted in FIG. 8, the content may be configured so as to be displayed on, as a display region (output unit 33), a windshield glass in front of the driver, with use of a so-called AR (Argumented Reality) image displaying projector 35.

As explained so far, the content output unit 130 depicted in FIG. 5 can be configured in various ways.

[3. Sequence of Processing Which Is Executed by Information Processing Device]

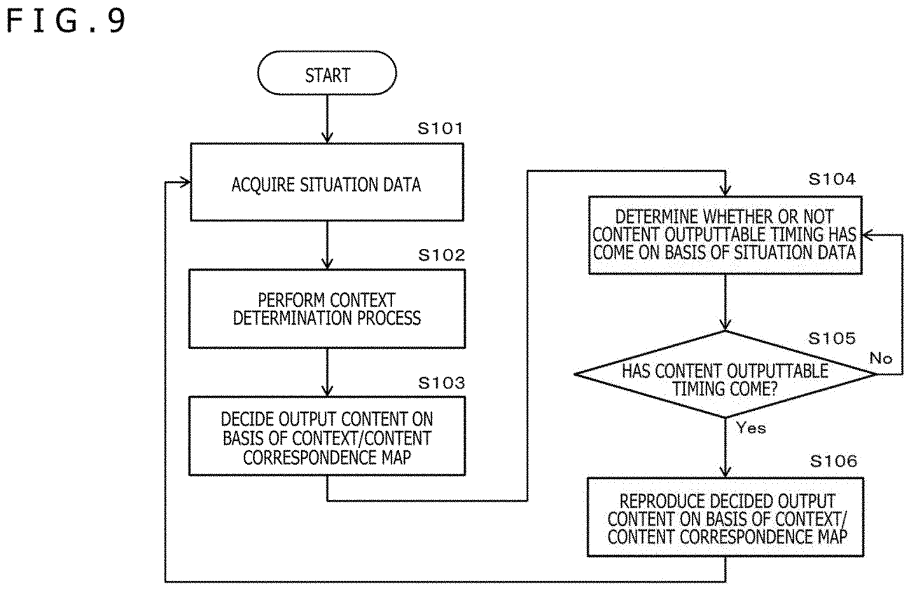

Next, an explanation will be given of a sequence of processing which is executed by the information processing device, with reference to a flowchart depicted in FIG. 9.

The flowchart in FIG. 9 is executed by the information processing device having the configuration depicted in FIG. 5.

Specifically, for example, the flowchart is executed by execution of processing in accordance with the program stored in the storage unit 150 by means of the control unit 140 of the information processing device depicted in FIG. 5.

Hereinafter, processes at the steps of the flowchart depicted in FIG. 9 will be sequentially explained.

(Step S101)

First, at step S101, the situation data acquisition unit 110 depicted in FIG. 5 acquires situation data.

As having been explained with reference to FIG. 5, the situation data acquisition unit 110 includes the driving action data acquisition unit 111, the sensor 112, the camera 113, the position information acquisition unit (GPS) 114, the LiDAR 115, and the situation data transfer unit 116.

With the above configuration, the driving situation of the driver of the automobile, that is, various kinds of situation data to be applied to analyze a context is acquired.

Specifically, examples of the various kinds of situation data include travel information such as a travel distance, a travel time, a travel time period, a travel speed, and a travel route, positional information, the number of occupants, the type of a travel road (for example, highway or ordinary road), operation information regarding an accelerator, a brake, or a steering wheel, and information regarding the surrounding condition of the automobile.

The situation data acquisition unit 110 acquires the situation data, and outputs the acquired data to the output content determination unit 120.

(Step S102)

Next, at step S102, the context determination unit 122 of the output content determination unit 120 depicted in FIG. 5 executes the context determination process.

The context determination unit 122 selects or determines a context that can be applied for determining the output content, on the basis of the situation data inputted from the situation data analysis unit 121.

(Step S103) Next, at step S103, the output content selection unit 123 of the output content determination unit 120 depicted in FIG. 5 selects optimal content corresponding to the driving situation (context) by using the map stored in the context/content correspondence map storage unit 124.

As explained above, data on the correspondence between contexts and output content such as that depicted in FIG. 6 is stored in the context/content correspondence map storage unit 124.

The output content selection unit 123 compares the context inputted from the context determination unit 122 with the contexts registered in the context/content correspondence map, selects a matching or similar entry, and determines, as the output content, output content registered in the selected entry.

(Steps S104 to S105)

The following steps at steps S104 to S106 are executed by the content output unit 130 depicted in FIG. 5.

First, at step S104, the content reproduction unit 131 of the content output unit 130 determines whether or not a content outputtable timing has come on the basis of the situation data.

That is, the content outputtable timing is a timing when the automobile is parked. The content reproduction unit 131 determines whether or not the automobile is parked on the basis of the situation data.

In the case where a parked state of the automobile is determined and the content is determined to be outputtable at step S105, the processing proceeds to step S106.

On the other hand, in the case where a non-parked state of the automobile is determined and the content is determined to be not outputtable at step S105, the processing returns to step S104, and the determination process of whether or not the content outputtable timing based on the situation data has come is continued.

(Step S106)

In the case where the parked state of the automobile is determined and the content is determined to be outputtable at step S105, the processing proceeds to step S106 to output the content.

That is, the content selected by application of the context/content correspondence map at step S103 is outputted.

The output content corresponds to the context, i.e., the situation of the driver.

The reproduction content is outputted with use of the display unit (display) 132, the projector 133, and the loudspeaker 134 of the content output unit 130 depicted in FIG. 5.

Note that the content is not limited to moving image content, and various kinds of content such as still image content or content including only a sound can be outputted.

The driver of the automobile views the content corresponding to the current situation of the driver, and thus, can feel, as an own problem, the reality of a scene of a risk or an accident included in the viewing content. Accordingly, through the content viewing, the safe driving consciousness of the driver can be improved.

[4. Configuration Example of Information Processing Device]

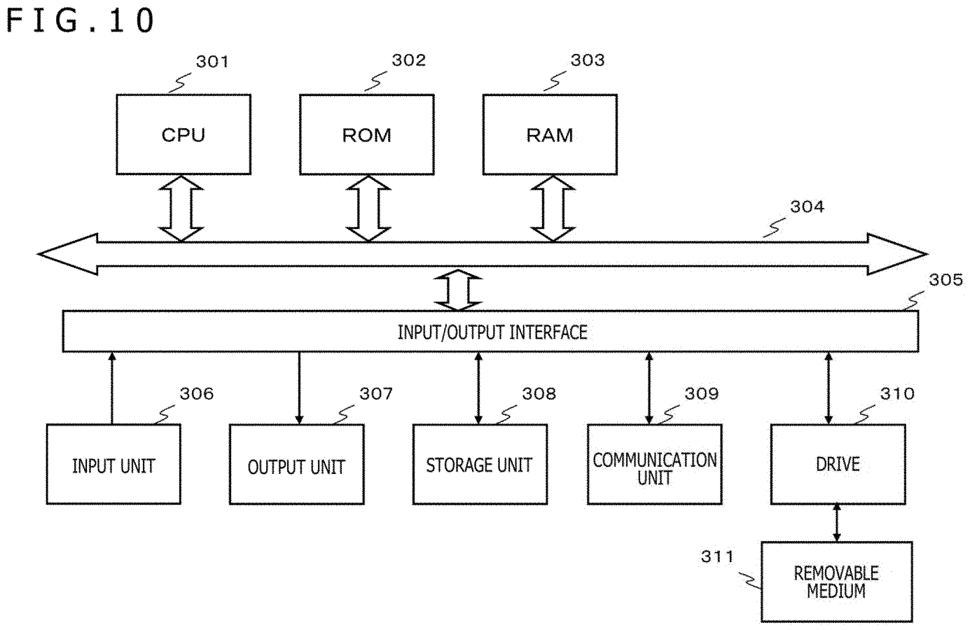

Next, a specific hardware configuration example of the information processing device having been explained with reference to FIG. 5, will be explained with reference to FIG. 10.

A CPU (Central Processing Unit) 301 functions as a data processing unit that executes various processes in accordance with a program stored in a ROM (Read Only Memory) 302 or a storage unit 308. For example, the CPU 301 executes the processes in accordance with the sequence explained in the aforementioned embodiment. A program to be executed by the CPU 301 and data are stored in a RAM (Random Access Memory) 303. The CPU 301, the ROM 302, and the RAM 303 are connected to one another via a bus 304.

The CPU 301 is connected to an input/output interface 305 via the bus 304. An input unit 306 including, for example, various switches, a keyboard, a touch penal, a mouse, a microphone, and a situation data acquisition unit such as a sensor, a camera, or a GPS, and an output unit 307 including a display and a loudspeaker, etc., are connected to the input/output interface 305.

The CPU 301 receives an input of a command or situation data, etc., inputted from the input unit 306, executes various processes on the command or situation data, etc., and outputs the processing result to the output unit 307, for example.

The storage unit 308 connected to the input/output interface 305 includes a hard disk, for example, and stores a program to be executed by the CPU 301 and various kinds of data. A communication unit 309 functions as a transmission/reception unit for data communication over a network such as the internet or a local area network, and communicates with an external device.

A drive 310 connected to the input/output interface 305 drives a removable medium 311 such as a magnetic disk, an optical disk, a magneto-optical disk, or a semiconductor memory such as a memory card, and executes data recording or reading.

[5. Conclusion of Configuration of the Present Disclosure]

An embodiment of the present disclosure has been explained in detail with reference to the specific embodiment. However, a person skilled in the art obviously could make modifications or substitutions within the scope of the gist of the present disclosure. That is, the present invention has been disclosed by being exemplified by the embodiment and should not be interpreted in a limited manner. To assess the gist of the present disclosure, the claims should be considered.

Note that the technique disclosed in the present description can also take the configurations as follows.

(1) An information processing device including:

a situation data acquisition unit that acquires driving situation data of an automobile;

an output content determination unit that determines output content on the basis of the situation data; and

a content output unit that outputs the output content determined by the output content determination unit, in which

the output content determination unit determines, as the output content, content including details of a situation that matches or that is similar to the situation data.

(2) The information processing device according to (1), in which

the output content determination unit determines, as the output content, content including details of a risk or an accident in the situation that matches or that is similar to the situation data.

(3) The information processing device according to (1) or (2), in which

the information processing device includes a storage unit having stored therein a context/content correspondence map in which a context indicating the situation data and content corresponding to the context are registered in association with each other, and

the output content determination unit determines, as the output content, content including details of the situation that matches or that is similar to the situation data, by referring to the context/content correspondence map.

(4) The information processing device according to any one of (1) to (3), in which

the content output unit executes content output in a time period during which the automobile is parked.

(5) The information processing device according to any one of (1) to (4), in which

the content output unit determines whether or not the automobile is parked on the basis of the situation data, and executes content output in a time period during which the automobile is parked.

(6) The information processing device according to any one of (1) to (5), in which

the situation data acquisition unit acquires at least any of automobile information regarding a travel speed, a travel time period, whether or not sudden braking has been applied, whether or not sudden start has been performed, or whether or not sudden steering has been performed.

(7) The information processing device according to any one of (1) to (6), in which

the content output unit includes at least any of a display unit mounted on the automobile or a mobile terminal of a driver.

(8) The information processing device according to any one of (1) to (7), in which

image display through the content output unit is executed on an automobile windshield to which a projector is applied.

(9) An information processing method which is performed by an information processing device, the method including:

a situation data acquisition step of acquiring driving situation data of an automobile by means of a situation data acquisition unit;

an output content determination step of determining output content on the basis of the situation data by means of an output content determination unit; and

a content output step of outputting the output content determined by the output content determination unit by means of a content output unit, in which

in the output content determination step,

as the output content, content including details of a situation that matches or that is similar to the situation data is determined.

(10) A program which causes an information processing device to execute information processing including:

a situation data acquisition step of causing a situation data acquisition unit to acquire driving situation data of an automobile;

an output content determination step of causing an output content determination unit to determine output content on the basis of the situation data; and

a content output step of causing a content output unit to output the output content determined by the output content determination unit, in which

in the output content determination step,

as the output content, content including details of a situation that matches or that is similar to the situation data is determined.

Further, the series of processes described herein can be executed by hardware, software, or a composite configuration thereof. In the case where the processes are executed by software, a program having a process sequence therefor recorded therein can be executed after being installed in a memory incorporated in dedicated hardware in a computer, or can be executed after being installed in a general-purpose computer capable of various processes. For example, such a program may be previously recorded in a recording medium. The program can be installed in the computer from the recording medium. Alternatively, the program can be received over a network such as a LAN (Local Area Network) or the internet, and be installed in a recording medium such as an internal hard disk.

Note that the processes described herein are not necessarily executed in the described time-series order, and the processes may be executed parallelly or separately, as needed or in accordance with the processing capacity of a device to execute the processes. Further, in the present description, a system refers to a logical set configuration including a plurality of devices, and the devices of the respective configurations are not necessarily included in the same casing.

### INDUSTRIAL APPLICABILITY

As explained so far, with the configuration according to one embodiment of the present disclosure, a configuration of selecting content corresponding to the driving situation of a driver and presenting the content to the driver, thereby enabling improvement of the safe driving consciousness of the driver, can be implemented.

Specifically, the configuration includes a situation data acquisition unit that acquires automobile driving situation data, an output content determination unit that determines output content on the basis of the situation data, and a content output unit that outputs the output content determined by the output content determination unit, in which the output content determination unit determines, as the output content, content including the details of a situation that matches or that is similar to the situation data. The output content determination unit determines, as the output content, content including the details of a risk or an accident in a situation that matches or that is similar to the situation data.

With the present configuration, a configuration of selecting content corresponding to the driving situation of a driver and presenting the content to the driver, thereby enabling improvement of the safe driving consciousness of the driver, can be implemented.

### REFERENCE SIGNS LIST

10 Display unit

20 Viewer (driver)

30 Automobile

31, 32, 33 Output unit

35 AR Image displaying projector

110 Situation data acquisition unit

111 Driving action data acquisition unit

112 Sensor

113 Camera

114 Position information acquisition unit

115 LiDAR

116 Situation data transfer unit

120 Output content determination unit

121 Situation data analysis unit

122 Context determination unit

123 Output content selection unit

124 Context/content correspondence map

125 Content storage unit

130 Content output unit

131 Content reproduction unit

132 Display unit

133 Projector

134 Loudspeaker

140 Control unit

150 Storage unit

301 CPU

302 ROM

303 RAM

304 Bus

305 Input/output interface

306 Input unit

307 Output unit

308 Storage unit

309 Communication unit

310 Drive

311 Removable medium

1. An information processing device comprising:
a situation data acquisition unit that acquires driving situation data of an automobile;
an output content determination unit that determines output content on a basis of the situation data; and
a content output unit that outputs the output content determined by the output content determination unit, wherein
the output content determination unit determines, as the output content, content including details of a situation that matches or that is similar to the situation data.

2. The information processing device according to claim 1, wherein
the output content determination unit determines, as the output content, content including details of a risk or an accident in the situation that matches or that is similar to the situation data.

3. The information processing device according to claim 1, wherein
the information processing device includes a storage unit having stored therein a context/content correspondence map in which a context indicating the situation data and content corresponding to the context are registered in association with each other, and
the output content determination unit determines, as the output content, content including details of the situation that matches or that is similar to the situation data, by referring to the context/content correspondence map.

4. The information processing device according to claim 1, wherein
the content output unit executes content output in a time period during which the automobile is parked.

5. The information processing device according to claim 1, wherein
the content output unit determines whether or not the automobile is parked on a basis of the situation data, and executes content output in a time period during which the automobile is parked.

6. The information processing device according to claim 1, wherein
the situation data acquisition unit acquires at least any of automobile information regarding a travel speed, a travel time period, whether or not sudden braking has been applied, whether or not sudden start has been performed, or whether or not sudden steering has been performed.

7. The information processing device according to claim 1, wherein
the content output unit includes at least any of a display unit mounted on the automobile or a mobile terminal of a driver.

8. The information processing device according to claim 1, wherein
image display through the content output unit is executed on an automobile windshield to which a projector is applied.

9. An information processing method which is performed by an information processing device, the method comprising:
a situation data acquisition step of acquiring driving situation data of an automobile by means of a situation data acquisition unit;
an output content determination step of determining output content on a basis of the situation data by means of an output content determination unit; and
a content output step of outputting the output content determined by the output content determination unit by means of a content output unit, wherein
in the output content determination step,
as the output content, content including details of a situation that matches or that is similar to the situation data is determined.

10. A program which causes an information processing device to execute information processing including:
a situation data acquisition step of causing a situation data acquisition unit to acquire driving situation data of an automobile;
an output content determination step of causing an output content determination unit to determine output content on a basis of the situation data; and
a content output step of causing a content output unit to output the output content determined by the output content determination unit, wherein
in the output content determination step,
as the output content, content including details of a situation that matches or that is similar to the situation data is determined.
